(19) United States
(12) Patent Application Publication
(10) Pub. No.: US 2009/0319542 A1
(43) Pub. Date: Dec. 24, 2009

(54) SYSTEMS AND METHODS TO AUTOMATICALLY REPLACE CONTENT IN A RANGE OF SPREADSHEET CELLS WITH INFORMATION FROM A DATABASE

(76) Inventors: Pierre Jean Le Brazidec, Guichen (FR); Florent Migeon, Clichy (FR)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/142,335

(22) Filed: Jun. 19, 2008

(51) Int. Cl. G06F 17/30; G06F 17/28

(52) U.S. Cl. 707/100; 715/212; 707/E17.044

(57) ABSTRACT

According to some embodiments, a system, method, means, and/or computer program code are provided to facilitate use of a spreadsheet application to access information stored in a multi-dimensional data source. Some embodiments include receiving, at an analyzer module, a change indication from the spreadsheet application, the spreadsheet application being adapted to provide a user display having multiple rows and columns of cells, each cell being capable of containing a formula. It may be determined that the change indication is associated with range of multiple cells and that every cell in the range contains a formula of a pre-determined type. Based on an active cell associated with the change indication, information stored in the a multi-dimensional data source may be retrieved. Formulas in at least some of the cells in the range may then be automatically replaced in accordance with the retrieved information.

### FIELD

Some embodiments of the present invention relate to business information, business intelligence, and/or enterprise systems. In particular, some embodiments relate to systems and methods to automatically replace content in a range of spreadsheet cells with information from one or more business information, business intelligence, and/or enterprise system databases.

### BACKGROUND

A business information, business intelligence, and/or enterprise system can improve an organization's ability to monitor and manage data in a complex business environment. For example, the systems offered by Business Objects SA of Levallois-Perret, France and SAP AG of Walldorf, Germany, provide components and tools that allow users to monitor, retrieve, view and manipulate business information, including business warehouse data stored and maintained as part of a company's overall business intelligence tools. By way of examples only, business information might be associated with a number of different product lines, profit values, customer groups, fiscal years, distribution regions, product costs, product quantities, revenues, and/or dates. Moreover, the business information may be stored and retrieved in a variety of ways. Examples of data sources include databases, such as, relational, transactional, hierarchical, multidimensional (e.g., OLAP), object oriented databases, and the like. Further data sources may include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC) and the like.

In some cases, a user needs to retrieve some of the stored business information according to various intents: explore the information, create a display or report that shows the information and the like. The user may, for example, import a particular set of information into a spreadsheet application by defining various cells in a spreadsheet. For example, the user may associate a particular row with a measure such as profit and a number of columns with different fiscal years, where the years are associated with a dimension. Measures and dimensions may be defined in a metadata model associated with the stored business information.

It can be difficult, however, to define a display or report in this way, especially when a relatively large amount of information is needed by the user. For example, a user might want to view sales figures for fifty different products in a single display or report. Individually defining rows for each of the products might be an impractically time consuming and/or error prone process.

It would be desirable to provide improved methods and systems that facilitate an access of business information by a user, including situations where the user is interested in a relatively large amount data.

### BRIEF DESCRIPTION OF THE DRAWINGS

FIG. 1 is a block diagram of a system according to some embodiments of the present invention.

FIG. 2 illustrates how information is stored and/or accessed in accordance with some embodiments of the present invention.

FIG. 3 illustrates a spreadsheet application in a user display.

FIG. 4 illustrates multi-dimensional data being displayed via a spreadsheet according to some embodiments of the present invention.

FIG. 5 illustrates a spreadsheet's automatic multiple-cell fill function.

FIG. 6 is a flow diagram of a method used in some embodiments.

FIG. 7 illustrates a user selection of a multiple-cell fill function in accordance with some embodiments of the present invention.

FIG. 8 illustrates a spreadsheet where the content of multiple cells has been replaced with information described by a metadata model in accordance with some embodiments.

FIG. 9 is an information flow diagram according to some embodiments of the present invention.

FIGS. 10 and 11 are exemplary embodiments illustrating the present invention.

FIGS. 12 and 13 illustrate further examples of embodiments of the present invention.

FIG. 14 is a block diagram of an apparatus in accordance with some embodiments of the present invention.

FIG. 15 illustrates a user selection of a multiple-cell fill function in connection with more than one active cell accordance with another embodiment of the present invention.

### DETAILED DESCRIPTION

To alleviate problems inherent in the prior art, some embodiments of the present invention introduce systems, methods, computer program code and/or means to automatically replace content in a range of spreadsheet cells with information from one or more business information, business intelligence, and/or enterprise system databases. Some embodiments are described herein as accessing Online Analytic Programming (OLAP) information associated with a multi-dimensional data schema. Note, however, that embodiments may be associated with other types of information including data described by a metadata model (e.g., which may itself include metadata structures) associated with the data. Such data can included information stored in one or more data sources, such as relational databases.

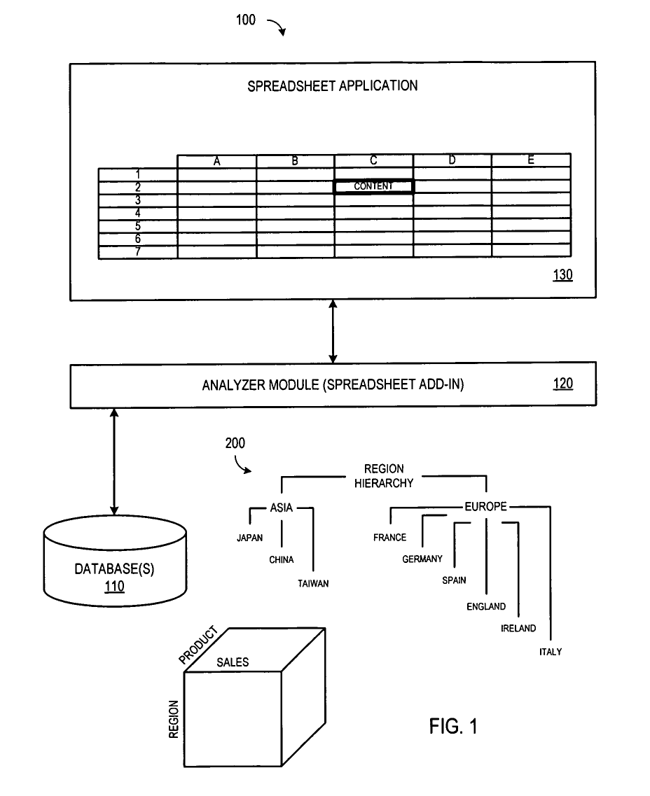

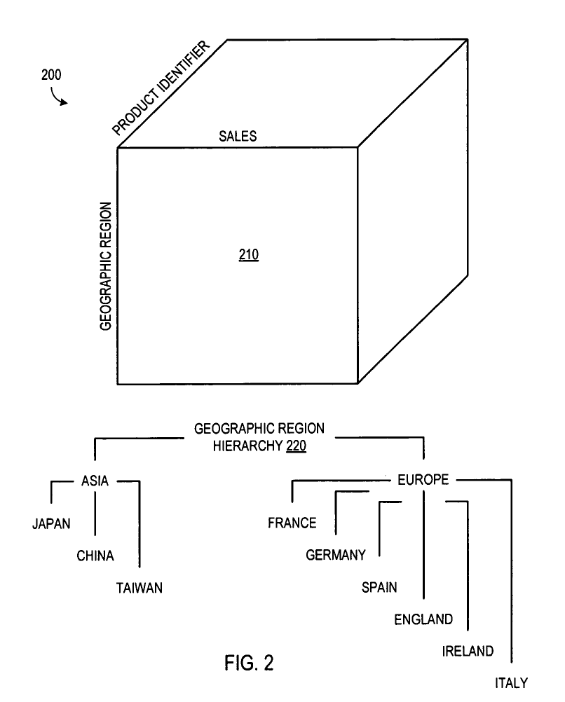

FIG. 1 is a diagram of a system 100 according to some embodiments of the present invention. The system 100 includes one or more databases 110 that may store information, such as business information. For example, FIG. 2 illustrates information 200 that might be stored and/or accessed in accordance with some embodiments of the present invention. In particular, the information 200 includes an OLAP cube 210. An OLAP cube 210 or hypercube may comprise, for example, a data structure storing financial information as numeric facts (or “measures”) categorized by dimensions. The OLAP cube 210 has a metadata model describing aspects of the cube, such as, the measures, the dimensions, the relationships or hierarchy of the dimensions, and the like. Although an OLAP cube 210 is illustrated in FIG. 2, note that embodiments may be associated with any multi-dimensional data source. The OLAP cube 210 illustrated in FIG. 2 stores measures associated with sales, product identifier, and geographic region dimensions. Note that the OLAP cube 210 may store information with any number of dimensions. In some embodiments, the stored information 200 may be accessed using Multi-Dimensional Expressions (MDX) which is a declarative query and data manipulation language similar to Structured Query Language (“SQL”) but adapted for multi-dimensional data.

The stored information 200 may include and/or be described by a metadata model. The metadata model may, for example, include relationships between data elements, common and multilingual names for the elements, descriptions of elements, data lineage for data elements, and the like. The stored information 200 may, in some cases, be arranged in a hierarchy structure 220 providing a series of parent-child relationships (e.g., where a parent member represents a consolidation of children members). A hierarchy usually has more than one level and may or may not be symmetrical. Symmetry for hierarchies includes balance (where all branches end at the same level), leveling (where all members on a certain level are derived from a single source), and the like.

For example, the hierarchy structure 220 illustrated in FIG. 2 organizes the geographic region dimension in a first level as representing either “Asia” or “Europe.” Moreover, the “Europe” region is further organized at a lower level as including the following sibling regions: “France,” “Germany,” “Spain,” “England,” “Ireland,” and “Italy.”

Referring again to FIG. 1, an analyzer module 120 may act as an interface between the databases 110 and a spreadsheet application 130. The spreadsheet application 130 might be associated with, for example, the Microsoft® Excel® and IBM® Lotus 1-2-3® spreadsheet programs. The analyzer module 120 might comprise, for example, a spreadsheet add-in such as the BusinessObjects Extended Analytics Analyzer Excel Add-In from Business Objects SA. As used herein, a spreadsheet “add-in” may refer to, for example, a plug-in component or module that executes in association with a spreadsheet application to provide additional functionality for a user. Note that that the analyzer module 120 and the spreadsheet application 130 might execute at a first device (e.g., a user PC or workstation) while the databases 110 are stored at a second device, remote from the first device. According to some embodiments, some or all of the information in the databases 110 may be co-located with the device executing the analyzer module 120 and spreadsheet application 130. According to still other embodiments, some or all of the spreadsheet application 130 executes via a web based interface.

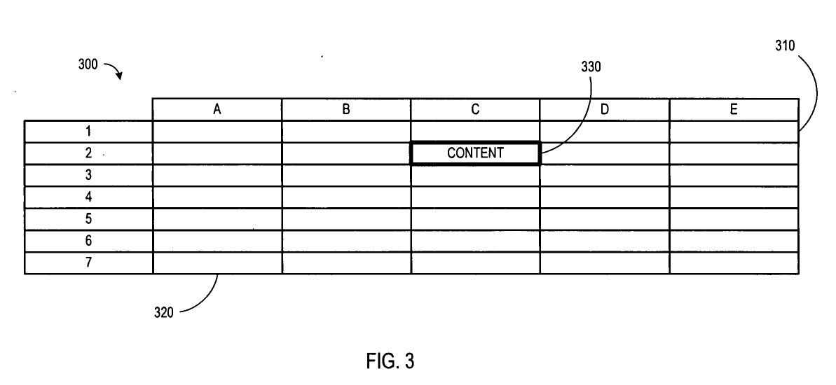

According to some embodiments, a user may define and view a spreadsheet, using the spreadsheet application 130, in order to have free form access to the information in the databases 110. For example, FIG. 3 illustrates a spreadsheet user display 300 that includes cell rows 310 (rows 1 through 7) and columns 320 (columns A through E). Note that the display 300 illustrated in FIG. 3 may only represent a small portion of an actual spreadsheet. For example, a spreadsheet might include thousands of rows 310 and/or columns 320.

A user may select one or more of the spreadsheet cells to represent a currently active cell 330. For example, a user might position a cursor over a cell and perform an action (e.g., a mouse click) to designate that cell as the currently active cell.

Each cell in the spreadsheet user display 300 may contain content, such as a numeric value, text, an image, or a formula. By way of example, the active cell 330 of FIG. 3 (cell C2) might contain the formula “=A2+B2.” In this case, the spreadsheet application 130 may automatically compute the appropriate value (based on the current content stored in cells A2 and B2) to be displayed in the active cell 330. According to some embodiments, the spreadsheet user display 300 may further include graphical representations (e.g., charts) representing the content of the various cells.

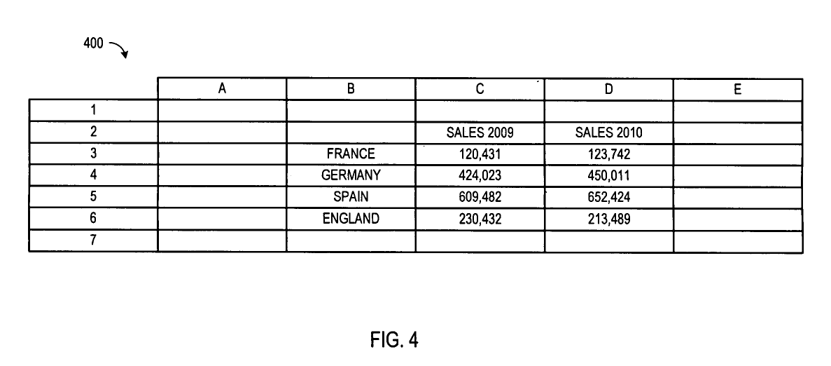

The spreadsheet user display 300 may help a user access and understand the information stored in, for example, the OLAP cube 210. Consider FIG. 4, which illustrates information from a multi-dimensional database (such as OLAP data) being displayed via a spreadsheet 400 according to some embodiments of the present invention. In this case, the user has created a report such that the cells in rows 3 through 6 of column B define four regions (France, Germany, Spain, and England) while the cells in columns C and D of row 2 define sales years (2009 and 2010). The analyzer module 120 may retrieve information from the OLAP cube 210 and insert the proper numerical values in the spreadsheet (e.g., to indicate that German sales in 2010 were “450,011” as displayed in cell D4 of the spreadsheet 400).

The analyzer module 120 may comprise a registered automation add-in of the spreadsheet application 130 that receives notifications from the spreadsheet application 130 in the form of “events.” For example, the spreadsheet application 130 might issue an event to the analyzer module 120 whenever the active cell is changed by the user.

The analyzer module 120 may also store and/or recognize information in cells using pre-determined types of formulas. For example, the analyzer module 120 might store and/or recognize the following type of formula in spreadsheet cells:

=AnalyzerOLAPMember(fullName,displayName)

where displayName is a string representing what should be shown on the user's display and fullName defines where the information is actually stored in the OLAP cube 210. The full name may correspond to an element in the metadata model, which is associated with a cell in the OLAP cube 210. By way of example only, cell B3 of the spreadsheet 400 illustrated in FIG. 4 might contain the formula:

=AnalyzerOLAPMember(“[Region].[Europe].[France]”,“France”)

Note that such a formula might include other parameters, such as a unique identifier (e.g., a unique alphanumeric string that might be used to correlate information even when a display name and/or full name has been changed) associated with the data, dimension information, hierarchy information, and/or metadata.

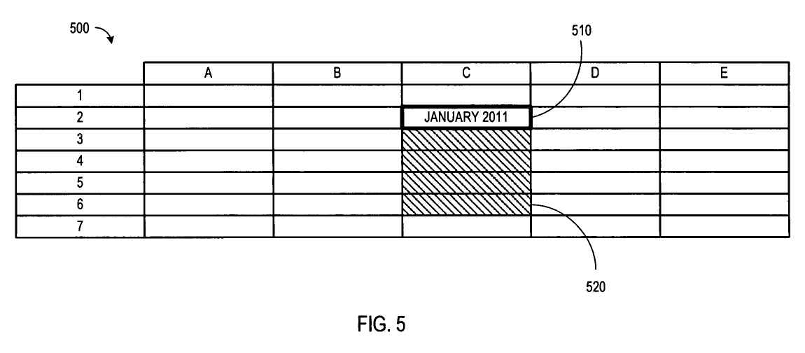

The spreadsheet application 130 is not specifically designed to access information in a multi-dimensional database, such as the OLAP cube 210. Instead, the spreadsheet application 130 includes features and functions that may be helpful to a user as he or she creates normal spreadsheets. One of these functions is an “automatic multiple-cell fill” ability illustrated by the spreadsheet 500 of FIG. 5. In this case, the user designates an active cell 510 (cell C2) that contains a “predictable” type of data (e.g., data commonly found in a sequence such as a date or numerical series). The user further designates an additional set of cells in a region 520 (cross-hatched in FIG. 5) and instructs the spreadsheet application to automatically place content into those cells based on the predictable data in the active cell 510. For example, in FIG. 5 the active cell contains the date “January 2011” and the user has selected the four cells below the active cell (C3 through C6) to be automatically filled with data. In the case of the Excel spreadsheet application, this may be performed by dragging a “fill handle” icon, such as an icon displayed in connection with a selection highlight function. As a result of the user's request, the spreadsheet application would automatically populate cells C3 through C6 with “February 2011,” “March 2011,” “April 2011,” and “May 2011,” respectively.

In some cases, the active cell 510 will not contain content that can be used by the spreadsheet application 130 to predict what information is appropriate for neighboring cells. For example, the cell might merely contain text (e.g., “dog”) or a formula. As a result, the spreadsheet application 130 may simply copy the content of the active cell (e.g., the formula) to each and every cell in the selected region 520.

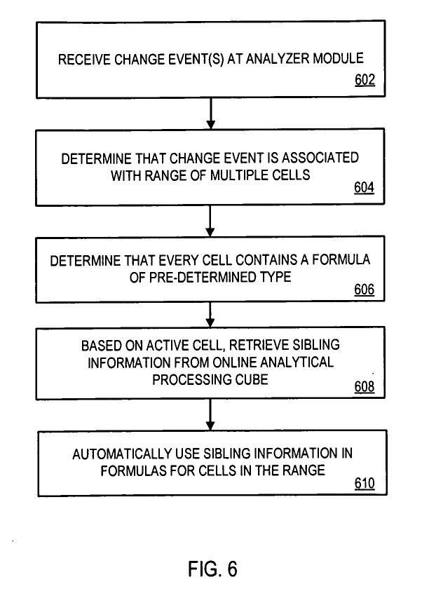

According to some embodiments, this automatic fill-in feature of the spreadsheet application 130 may be advantageously used by the analyzer module 120 to facilitate an access of business information stored in the databases 110. For example, FIG. 6 is a flow diagram depicting process steps that may be performed by the business information enterprise system 100 of FIG. 1. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 602, one or more change events may be received at an analyzer module. For example, the analyzer module might receive an indication of a change event from a spreadsheet application. At 604, it is determined that the change event is associated with range of multiple spreadsheet cells. For example, the change events received from the spreadsheet application might indicate that cells A1 through A10 have been changed at substantially the same time. At 606, it is determined that every cell in the range contains a formula of a pre-determined type. For example, it might be determined whether or not all of the cells contain the AnalyzerOLAPMember formula previously described.

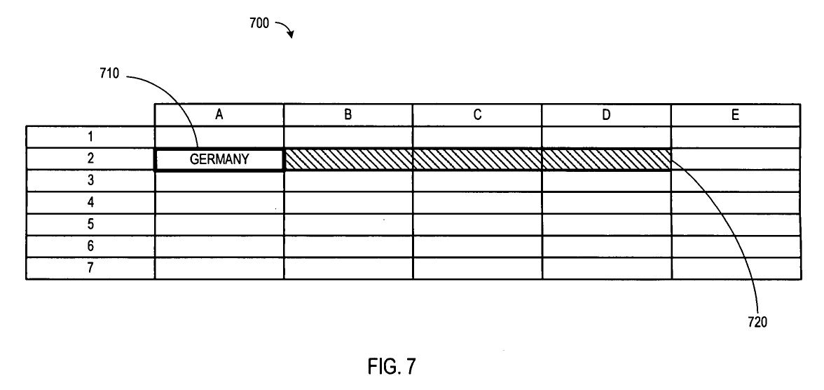

Consider, for example, FIG. 7 which illustrates a user selection of a multiple-cell fill function in a spreadsheet 700 in accordance with some embodiments of the present invention. Here, the user has selected A2 as the active cell 710 and instructed the spreadsheet application to automatically fill-in cells B2 through D2. Moreover, the active cell 710 contained the formula:

=AnalyzerOLAPMember (“[Region].[Europe].[Germany]”,“Germany”)

Because the spreadsheet application is unable predict content for the automatic fill-in function, the spreadsheet application simply copies the same formula to each of the cells in the range B2 through D2. Moreover, the analyzer module receives an indication that those three cells received the new content at substantially the same time. Note that the spreadsheet application might, according to various embodiments, issue a single event indicating that those three cells changed or three individual events.

Refer again to FIG. 6. Based on an active cell associated with the change event, information stored in a multi-dimensional database, such as an OLAP cube, is retrieved at 608. For example, the active cell may be associated with a member and the retrieved information may represent siblings of that member in the OLAP cube. Moreover, the siblings may be associated with, for example, dimension members of a shared hierarchy level in the OLAP cube. At 610, formulas in at least some of the cells in the range are automatically replaced in accordance with the retrieved information. For example, information about a series of siblings of the member associated with the active cell may be used to create the formulas that are automatically placed in the range.

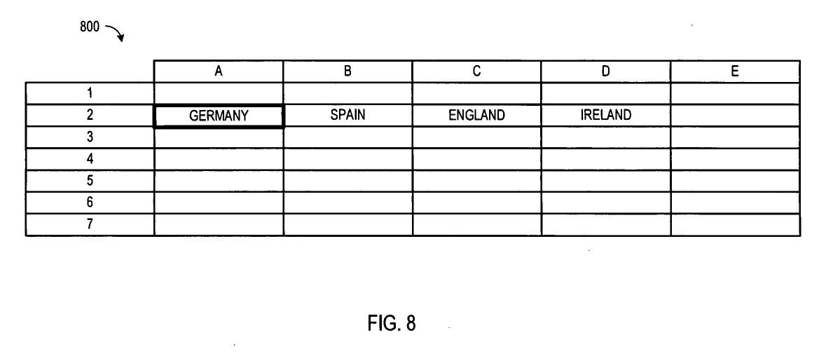

Consider, for example, FIG. 8 which illustrates a spreadsheet 800 where the content of multiple cells has been replaced with information from a multi-dimensional database, such as an OLAP cube, in accordance with some embodiments. In particular, the analyzer module determined that an OLAP cube member Germany was associated with the active cell A2, and therefore retrieved the next three siblings of that member from the cube (Spain, England, and Ireland). The analyzer module then updated the formulas for cells B2 through D2 with the sibling information. Note that without such steps, cells B2 through D2 would all have displayed “Germany.”

The information used to create new formulas for cells may be taken from a single level of a hierarchy structure. Consider, for example, a hierarchy structure that includes (with indentations representing hierarchy levels):

```
products
    hardware
        computers
            desktop PCs
            notebooks
            servers
        printers
        modems
        display monitors
    software
        games
        business applications
        multi-media programs
services
```

Now consider that a user has selected a cell referencing “computers” as his or her active cell and requested that the three cells to the right of the active cell be automatically filled in. In this case, the analyzer module might use the information associated with “printers,” “modems,” and “display monitors” to automatically create formulas for those three cells. Note that the information associated with “desktop PCs”, “notebooks,” and “servers” was not used according to this embodiment (because those members exist in a different level of the hierarchy).

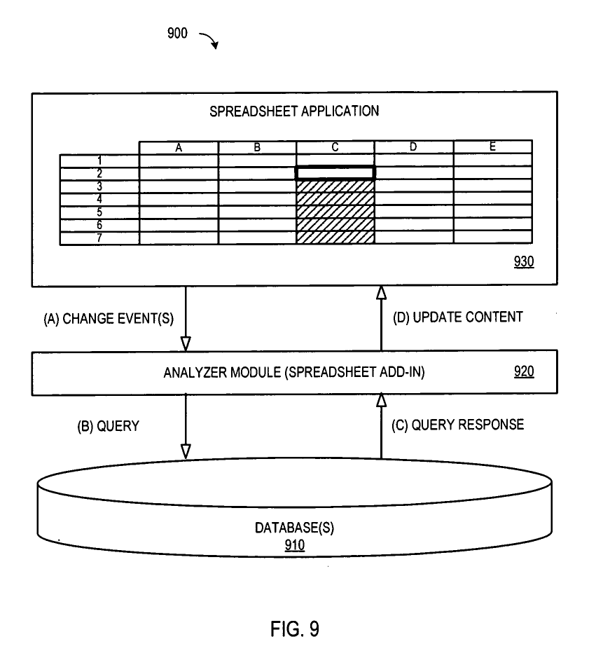

FIG. 9 is an information flow diagram 900 according to some embodiments of the present invention. The diagram 900 may be associated with, for example, steps that facilitate a display of information stored in one or more external databases 910 (e.g., one or more multi-dimensional data sources). The external databases 910 may, for example, store information about members such that at least some members are siblings of other members. According to some embodiments, the external databases 910 further store an extended metadata structure defining a hierarchy for the members. As used herein the “external” databases 910 may include one or more databases remote from a device executing a spreadsheet application 930 and an analyzer module 920 (e.g., an add-in or plug-in component of the spreadsheet application 930).

At action (A), the analyzer module 920 receives a change event from the spreadsheet application 930. The analyzer module 920 then determines that the change event is associated with (i) a set of multiple cells and (ii) an active cell associated with a first member. According to some embodiments, the analyzer module 920 further determines whether every cell in the range contains a formula of a pre-determined type (and, if the cells contain different types of formulas, no further action is taken).

At action (B), the analyzer module 920 constructs and issues a query to the external databases 910 asking for information about sibling members of the first member. The databases 910 respond with the requested information at action (C), and the analyzer module 920 automatically creates formulas for the range of cells using the information about the siblings of the first member. At action (D), the analyzer module 920 loads the automatically created formulas into the cells via the spreadsheet application 930.

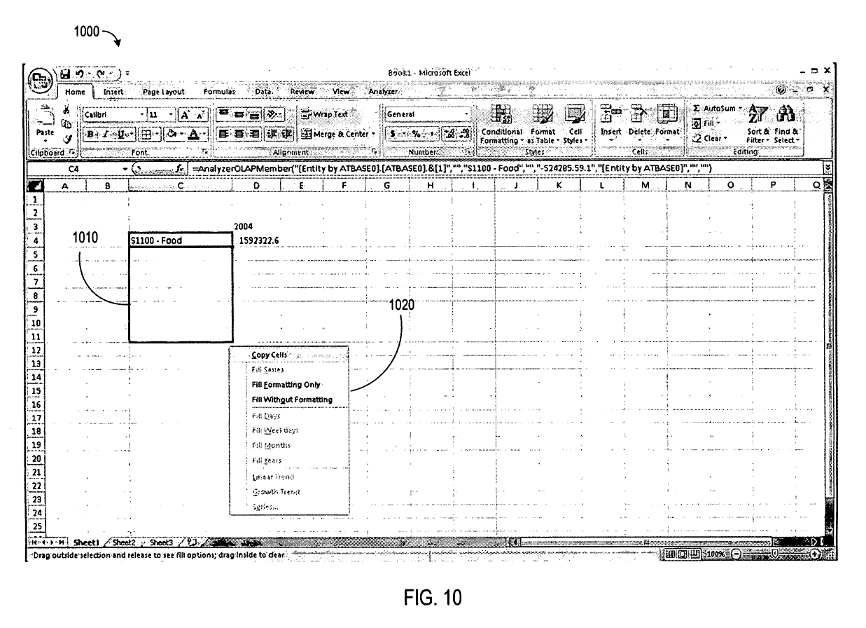

FIG. 10 illustrates an exemplary spreadsheet display 1000 illustrating some embodiments of the present invention. In this case, the user has made cell C4 (containing “S1100-Food”) the active cell and indicated via a pop-up selection 1020 that the region 1010 (cells C5 through C11) should be automatically filled-in. The spreadsheet application simply replicates the formula of cell C4 into each cell of the region 1010.

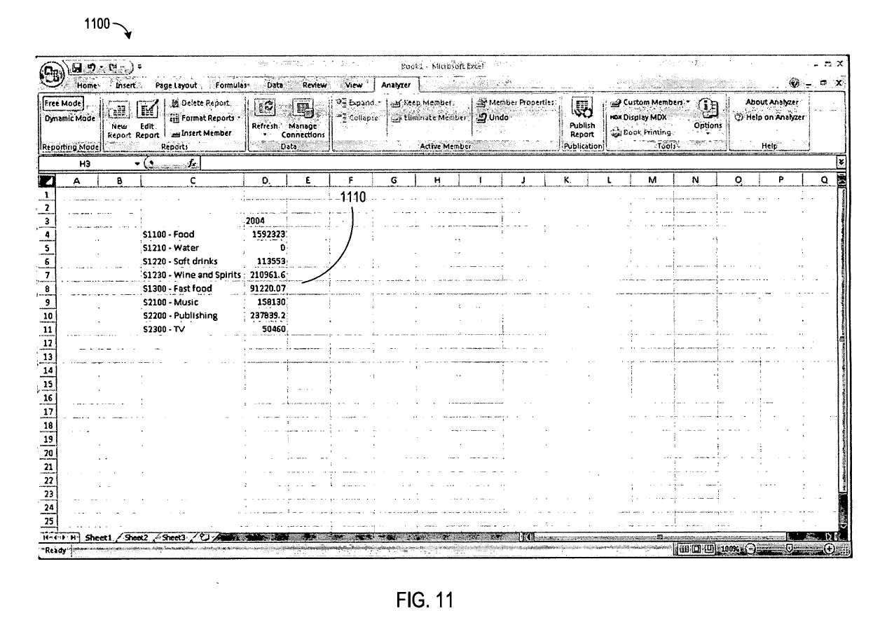

The analyzer add-in recognizes that seven identical cells (C5 through C11) have just been created, each containing the identical AnalyzerOLAPMember formula. As a result, the analyzer add-in retrieves information about the next seven siblings of “S1100-Food” from an OLAP cube and uses that information to populate formulas for the new cells 1110 as illustrated by the display 1100 of FIG. 11. Because these cells now define rows 5 through 11, the appropriate “2004” data is also automatically retrieved and displayed in cells D5 through D1.

Thus, according to some embodiments there may be two stages associated with an automatic fill-in function. In a first stage, a spreadsheet application (which is unaware of an metadata associated with a data source) simply replicates a formula of an active cell into every cell in a region designated by the user. In a second stage, an analyzer module replaces those formulas (and/or parameters of those formulas) with information about sibling members as appropriate in accordance with the metadata.

In some cases, there might not be enough siblings in the multi-dimensional data source or OLAP cube to populate the region selected by the user. For example, a user might make a cell active and automatically fill-in a region containing ten cells below the active cell. However, the OLAP cube may only contain six siblings after the member associated with the active cell. In this case, the analyzer module might create formulas for the first six cells in the region. The analyzer module might leave the content of the remaining four cells in the region (that is, the formula of the active cell that was replicated by the spreadsheet application into those four cells might remain). According to an alternate embodiment, the analyzer module might instead delete the content of the remaining four cells in the region.

Consider again a hierarchy structure that includes (with indentations representing hierarchy levels):

```
products
    hardware
        computers
            desktop PCs
            notebooks
            servers
        printers
        modems
        display monitors
    software
        games
        business applications
        multi-media programs
services
```

Now consider that a user has selected a cell referencing “computers” as his or her active cell and requested that the five cells below the active cell be automatically filled in. In this case, the analyzer module might use the information associated with “printers,” “modems,” and “display monitors” to automatically create formulas for the first three cells and clear out the information in the remaining two cells. Note that the information about members after “display monitors” was not used according to this embodiment (because there members are in different levels of the hierarchy or have different parents).

According to some embodiments, the analyzer module determines whether all of the newly created cells contain a formula of a pre-determined type. For example, the analyzer module might determine whether all of the newly created cells are of the AnalyzerOLAPMember type. If not, the analyzer module might not retrieve sibling data and might not automatically replace formulas. Moreover, according to some embodiments, the pre-determined formula type includes a set of parameters (e.g., associated with a full name, a display name, a dimension name, and/or a hierarchy name), and the analyzer module further determines if the formulas for all of the newly created cells contain identical parameters. If not, the analyzer module might again decide to not retrieve sibling data and/or to not automatically replace formulas.

In FIG. 8, the newly created cells represented a portion of the row to the right of the active cell. In FIG. 11, the newly created cells represented a portion of the column below the active cell. In both of these cases, subsequent sibling members were used to populate the cells (as would be the natural expectation of a user).

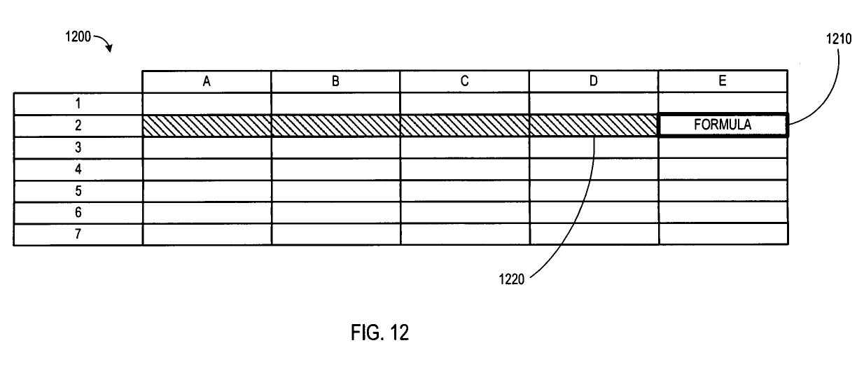

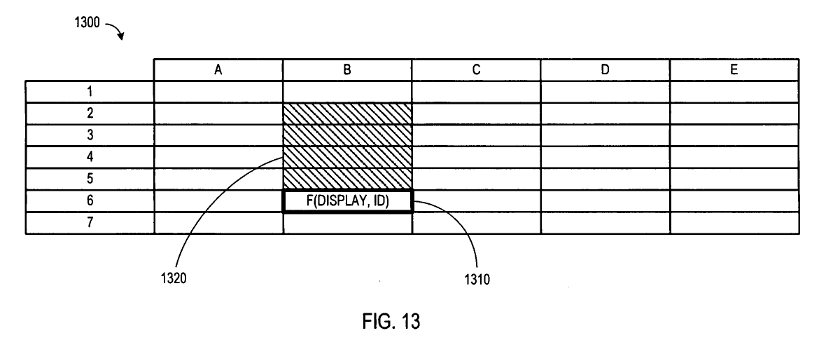

FIG. 12 illustrates another situation where a spreadsheet 1200 is used to select a region 1220 representing a portion of a row (row 2) adjacent and to the left of an active cell 1210. Similarly, FIG. 13 illustrates a spreadsheet 1300 where a user has a region 1320 representing a portion of a column (column B) adjacent and above an active cell 1310. In both FIGS. 12 and 13, the analyzer module might arrange for the information retrieved from the OLAP cube to represent prior (instead of subsequent) siblings of the member associated with the active cell.

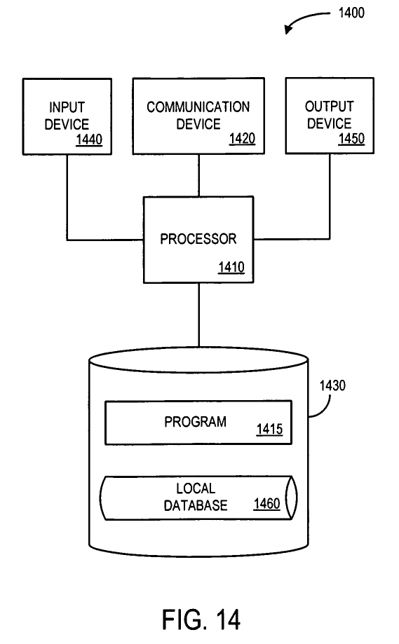

FIG. 14 is a block diagram of an apparatus 1400 in accordance with some embodiments of the present invention. The apparatus 1400 might, for example, execute a spreadsheet application and a spreadsheet plug-in or module similar to analyzer module 120 illustrated in FIG. 1. The apparatus 1400 comprises a processor 1410, such as one or more INTEL® Pentium® processors, coupled to a communication device 1420 configured to communicate via a communication network (not shown in FIG. 14). The communication device 1420 may be used to exchange OLAP or other business information, for example, with one or more multi-dimensional data sources (e.g., associated with remote databases or other devices).

The processor 1410 is also in communication with an input device 1440. The input device 1440 may comprise, for example, a keyboard, a mouse, or computer media reader. Such an input device 1440 may be used, for example, to select an active cell and/or to select cells that should be automatically filled with content. The processor 1410 is also in communication with an output device 1450. The output device 1450 may comprise, for example, a display screen or printer. Such an output device 1450 may be used, for example, to provide reports and/or display business information.

The processor 1410 is also in communication with a storage device 1430. The storage device 1430 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices.

The storage device 1430 stores a program 1415 for controlling the processor 1410. The processor 1410 performs instructions of the program 1415, and thereby operates in accordance any embodiments of the present invention described herein. For example, the processor 1410 may access a database that stores information about a plurality of members arranged in a hierarchy such that at least some members are siblings of other members. The processor 1410 might further execute a spreadsheet component for the manipulation of multiple rows and columns of cells that contain content, the spreadsheet component being adapted to (i) receive from a user an indication that content of a first cell is to be copied to a set of a plurality of cells neighboring the first cell, and (ii) generate at least one change indication in response to the indication received from the user. The processor 1410 may further execute a spreadsheet add-in component adapted to (i) receive the at least one change indication from the spreadsheet component, (ii) determine a first member associated with the first cell, and (iii) retrieve from the database information corresponding to siblings of the first member.

According to some embodiments, the spreadsheet add-in component is further adapted to dynamically change content of the neighboring cells based on the retrieved information corresponding to the siblings of the first member. The change of content might comprise, for example, replacing content for each neighboring cell with a pre-determined formula having a set of parameters, and the parameters may be defined by the spreadsheet add-in component for each neighboring cell based on the information retrieved from the database.

As used herein, information may be “received” by or “transmitted” to, for example: (i) the apparatus 1400 from other devices; or (ii) a software application or module within the apparatus 1400 from another software application, module, or any other source. As shown in FIG. 14, the storage device 1430 may also store a local information database 1460 according to some embodiments. The local information database 1460 may, for example, store information about some or all of the information associated with an OLAP cube, such as hierarchy information and/or information about sibling cells. According to some embodiments, the local information database 1460 stores “metadata” describing the content of an OLAP cube, a data warehouse, or any other data source.

The illustration and accompanying descriptions of devices and databases presented herein are exemplary, and any number of other arrangements could be employed besides those suggested by the figures. For example, multiple databases associated with different types of business information might be associated with the apparatus 1400.

As a result of embodiments described herein, a user may be able to create spreadsheet displays of business information more quickly as compared to prior approaches. Moreover, embodiments may help reduce errors associated with the definition of such reports and displays (e.g., because the user does not need to remember and enter the identity of each and every sibling member).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., some of the information associated with the applications and databases described herein may be combined or stored in separate systems). Similarly, although a particular information flow and user interactions have been given as examples, other steps may be performed in accordance with any embodiments described herein. For example, after selecting a set of cells to be automatically filled-in, a pop-up selection window might ask the user whether or not (and/or how) information from an external database should be applied to the newly created content.

Moreover, embodiments have been described with respect to a single active cell and the creation of new adjacent cells in the same column (or row). However, embodiments might also be applicable when there are multiple columns or multiple rows associated with the automatic fill-in function. For example, an automatic replacement may be simultaneously performed in connection with a plurality of initial cells, each initial cell being associated with a range of neighboring cells being changed.

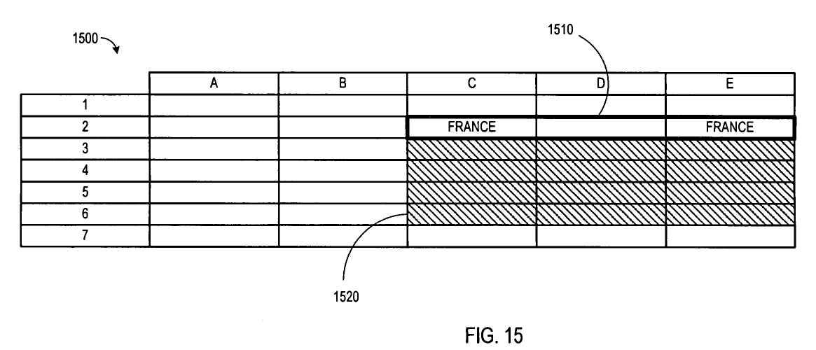

FIG. 15 illustrates a spreadsheet 1500 where a user has designated three initial cells 1510 to be automatically replicated in a three cell by four cell region 1520 in accordance with another embodiment of the present invention. In this case, the analyzer module may access information in an external database in order to automatically create appropriate formulas for the four cells in the region 1520 directly below the leftmost initial cell 1510. Similarly, the analyzer module may use the same information to automatically create formulas for the four cells in the region 1520 directly below the rightmost initial cell 1510. Since the center initial cell 1510 is blank, the cells below the center initial cell 1510 may not contain any content.

As still another example, consider again a hierarchy structure that includes (with indentations representing hierarchy levels):

```
products
    hardware
        computers
            desktop PCs
            notebooks
            servers
        printers
        modems
        display monitors
    software
        games
        business applications
        multi-media programs
services
```

Now consider a user who selects cell A1 referencing “hardware” as his or her active cell and requests that an eleven cell region defined by cells A2 through A12 be automatically filled in. In this case, the analyzer module might automatically only replace the parameters for cell A2 with information about the “software” member (as that is the only member in the same hierarchy level as the “hardware” member associated with active cell A1).

According to another embodiment, A1 and A2 might initially contain “hardware” and “computers,” respectively. A user might then select those two cells as initial cells and request that cells A3 through A9 be automatically filled-in. In this example, the following cells A1 through A9 might be automatically determined and filled-in for the user:

```
hardware
    computers
    printers
    modems
    display monitors
software
    games
    business applications
    multi-media programs
```

That is, depending the levels contained in the initial cells, the analyzer module might automatically replace formula parameters in the fill-in region with information about children (and perhaps grandchildren) of the members associated with the initial cells. In this case, members of lower levels in the hierarchy might be graphically distinguished within column A of the spreadsheet (e.g., via indentations or symbols, such as a “-” character, for each level of the hierarchy). According to yet another embodiment, a user might enter one or more special characters in an initial cell to indicate that descendants should be included in the automatically filled-in region. The special characters might indicate, by way of examples only, that all members up to level n should be included, that leaf members should be included, that members of the current level +n additional levels should be included, and/or that parent levels should be included.

Applicants have discovered that embodiments described herein may be particularly useful in connection with an access of information from a multi-dimensional data source via a spreadsheet application. Note, however, that other types of applications and databases, including transactional and relational databases, may also benefit from the invention.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer-readable medium having stored thereon processor-executable instructions, to facilitate use of a spreadsheet application to access information stored in an online analytical processing cube, that when executed by a processor result in the following:
receiving, at an analyzer module, a change indication from the spreadsheet application, the spreadsheet application being adapted to provide a user display having multiple rows and columns of cells, each cell being capable of containing a formula;
determining that the change indication is associated with range of multiple cells;
determining that every cell in the range contains a formula of a pre-determined type;
based on an active cell associated with the change indication, retrieving information stored in the online analytical processing cube; and
automatically replacing formulas in at least some of the cells in the range in accordance with the retrieved information.

2. The medium of claim 1, wherein the active cell is associated with a member and the retrieved information represents siblings of the member in the online analytical processing cube.

3. The medium of claim 2, wherein the process steps further comprise:
determining that the range of cells are either (i) a portion of a column adjacent and subsequent to the active cell or (ii) a portion of a row adjacent and subsequent to the active cell; and
arranging for the retrieved information to represent subsequent siblings of the member associated with the active cell.

4. The medium of claim 2, wherein the process steps further comprise:
determining that the range of cells are either (i) a portion of a column adjacent and prior to the active cell or (ii) a portion of a row adjacent and prior to the active cell; and
arranging for the retrieved information to represent prior siblings of the member associated with the active cell.

5. The medium of claim 2, wherein the siblings are associated with dimension members of a shared hierarchy level in the online analytical processing cube.

6. The medium of claim 2, wherein, based on the number of siblings in the online analytical processing cube, said replacing comprises replacing formulas in fewer than all of the cells in the range.

7. The medium of claim 1, wherein the change indication received from the spreadsheet application comprises a plurality of simultaneous cell changes.

8. The medium of claim 1, wherein the formula of the pre-determined type includes a set of parameters, and the process steps further comprise:
determining if the formula of the pre-determined type for each cell in the range contains identical parameters,
wherein said retrieving and replacing are performed only when the formula of the pre-determined type for each cell in the range contains identical parameters.

9. The medium of claim 8, wherein the set of parameters includes: (i) a full name, (ii) a display name, (iii) a dimension name, and (iv) a hierarchy name.

10. The medium of claim 1, wherein the analyzer module comprises a registered automation add-in of the spreadsheet application.

11. The medium of claim 1, wherein the automatic replacement is simultaneously performed in connection with a plurality of initial cells, each initial cell being associated with a range of neighboring cells being changed.

12. A system, comprising:
a database storing information about a plurality of members arranged in a hierarchy such that at least some members are siblings of other members;
a spreadsheet component for the manipulation of multiple rows and columns of cells that contain content, the spreadsheet component being adapted to:
receive from a user an indication that content of a first cell is to be copied to a set of a plurality of cells neighboring the first cell, and
generate at least one change event in response to the indication received from the user; and
a spreadsheet add-in component adapted to:
receive the at least one change event from the spreadsheet component,
determine a first member associated with the first cell, and
retrieve from the database information corresponding to siblings of the first member.

13. The system of claim 12, wherein the database is associated with multi-dimensional data source.

14. The system of claim 12, wherein the spreadsheet add-in component is further adapted to dynamically change content of the neighboring cells based on the retrieved information corresponding to the siblings of the first member.

15. The system of claim 14, wherein the change of content comprises replacing content for each of the neighboring cells with a pre-determined type of formula having a set of parameters, the parameters being defined by the spreadsheet add-in component for each neighboring cell based on the information retrieved from the database.

16. A method to facilitate a display to a user of information stored in an external database, the external database storing information about members such that at least some members are siblings of other members, the method comprising:
receiving, at an analyzer add-in of a spreadsheet application, a change indication from the spreadsheet application, the spreadsheet application supporting multiple rows and columns of cells to hold formulas;
determining that the change indication is associated with (i) a set of multiple cells and (ii) an active cell associated with a first member; and
retrieving, from the external database, information about sibling members of the first member.

17. The method of claim 16, further comprising:
automatically replacing formulas in the range of cells with the information about the sibling members of the first member.

18. The method of claim 17, further comprising:
determining that every cell in the range contains a formula of a pre-determined type, wherein said retrieving and replacing are only performed when every cell in the range contains the formula of a pre-determined type.

19. The method of claim 16, wherein the external database further stores an extended metadata structure defining a hierarchy for the members.

20. The method of claim 16, wherein the external database comprises a database remote from a device executing the spreadsheet application and the analyzer add-in.

21. The method of claim 16, wherein said retrieving comprises constructing and issuing a query from the analyzer add-in to the external database.
